(19) United States
(12) Patent Application Publication
(10) Pub. No.: US 2025/0067506 A1
(43) Pub. Date: Feb. 27, 2025

(54) TURBO-EXPANDER INTELLIGENT PERFORMANCE MONITORING SYSTEM

(71) Applicant: SAUDI ARABIAN OIL COMPANY, Dhahran (SA)

(72) Inventors: Mohammad Almusaiteer, Udhailiyah (SA); Abdulrahman Takrouni, Al Mubarraz (SA); Fahad Alghamdi, Udhailiyah (SA)

(73) Assignee: SAUDI ARABIAN OIL COMPANY, Dhahran (SA)

(21) Appl. No.: 18/456,359

(22) Filed: Aug. 25, 2023

(51) Int. Cl. F25J 3/02

(52) U.S. Cl. CPC F25J 3/0295; F25J 3/0209; F25J 2240/02; F25J 2280/50

(57) ABSTRACT

A method to perform operations of a natural gas liquid (NGL) plant equipment iws disclosed. The method includes obtaining real time process condition parameters of the NGL plant equipment, calculating, using an equation of state (EOS) and based on the real time process condition parameters, a compressibility factor of inlet and outlet streams of the NGL plant equipment, calculating, based on the calculated compressibility factor, a performance measure of the NGL plant equipment, and facilitating, based on the calculated performance measure, the operations of the NGL plant equipment.

### BACKGROUND

Raw natural gas is composed of hydrocarbons, incombustible gases (e.g., nitrogen) and impurities. A Natural Gas Liquids (NGL) plant is equipped with a series of fractionators that remove Nitrogen and other impurities and separate a mixture of light hydrocarbons into various pure products, such as methane, ethane, propane, butane, and pentanes as well as natural gasoline found in natural gas. The NGL plant usually includes multiple fractionation trains each made up of a number of fractionators.

A turboexpander, also referred to as a turbo-expander or an expansion turbine, is a centrifugal or axial-flow turbine, where high-pressure gas is expanded to produce work that is often used to drive a compressor or generator. The expanding high-pressure gas turns into the low-pressure exhaust gas from the turbine at a very low temperature, e.g., −150° C. or less depending upon the operating pressure and gas properties. Partial liquefaction of the expanded gas is not uncommon. Turboexpanders are used as sources of refrigeration in industrial processes such as NGL extraction from natural gas and other low-temperature processes.

The turboexpander includes three main loading devices, namely the centrifugal compressor, electrical generator and hydraulic brake. The centrifugal compressor and electrical generator allow the shaft power from the turboexpander to be recouped either to recompress the process gas or to generate electrical energy, lowering utility bills.

The polytropic compression process is a compression process where the thermodynamic path from suction to discharge pressure and temperature is divided into an infinite number of steps with each of these steps having the same (i.e., polytropic) efficiency. The polytropic efficiency is an incremental ratio of output power divided by input power, where a part of the input power is lost by friction or similar effects.

### SUMMARY

In general, in one aspect, the invention relates to a method to perform operations of a natural gas liquid (NGL) plant equipment. The method includes obtaining real time process condition parameters of the NGL plant equipment, calculating, using an equation of state (EOS) and based on the real time process condition parameters, a compressibility factor of inlet and outlet streams of the NGL plant equipment, calculating, based on the calculated compressibility factor, a performance measure of the NGL plant equipment, and facilitating, based on the calculated performance measure, the operations of the NGL plant equipment.

In general, in one aspect, the invention relates to an intelligent performance monitoring (IPM) system to perform operations of a natural gas liquid (NGL) plant equipment. The IPM system includes a computer processor and memory storing instructions, when executed by the computer processor comprising functionality for obtaining real time process condition parameters of the NGL plant equipment, calculating, using an equation of state (EOS) and based on the real time process condition parameters, a compressibility factor of inlet and outlet streams of the NGL plant equipment, calculating, based on calculated compressibility factor, a performance measure of the NGL plant equipment, and facilitating, based on the calculated performance measure, the operations of the NGL plant equipment.

In general, in one aspect, the invention relates to a system that includes a natural gas liquid (NGL) plant equipment of an NGL plant, a plurality of sensors disposed at an inlet and an outlet of the NGL plant equipment to measure real time process condition parameters of the NGL plant equipment, and an intelligent performance monitoring (IPM) system comprising functionality for obtaining the real time process condition parameters of the NGL plant equipment, calculating, using an equation of state (EOS) and based on the real time process condition parameters, a compressibility factor of inlet and outlet streams of the NGL plant equipment, calculating, based on calculated compressibility factor, a performance measure of the NGL plant equipment, and facilitating, based on the calculated performance measure, the operations of the NGL plant equipment.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1C show a system in accordance with one or more embodiments.

FIG. 2 shows a method flowchart in accordance with one or more embodiments.

FIGS. 3A-3B shows an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a method and system for performing operations of a natural gas liquid (NGL) plant equipment. In one or more embodiments, real time process condition parameters of the NGL plant equipment are obtained as input to an intelligent performance monitoring (IPM) system. The IPM system calculates, using an equation of state (EOS) and based on the real time process condition parameters, a compressibility factor of the inlet and outlet streams of the NGL plant equipment. Accordingly, the calculated compressibility factor is used to calculate performance measures of the NGL plant equipment and facilitate the operations of the NGL plant equipment.

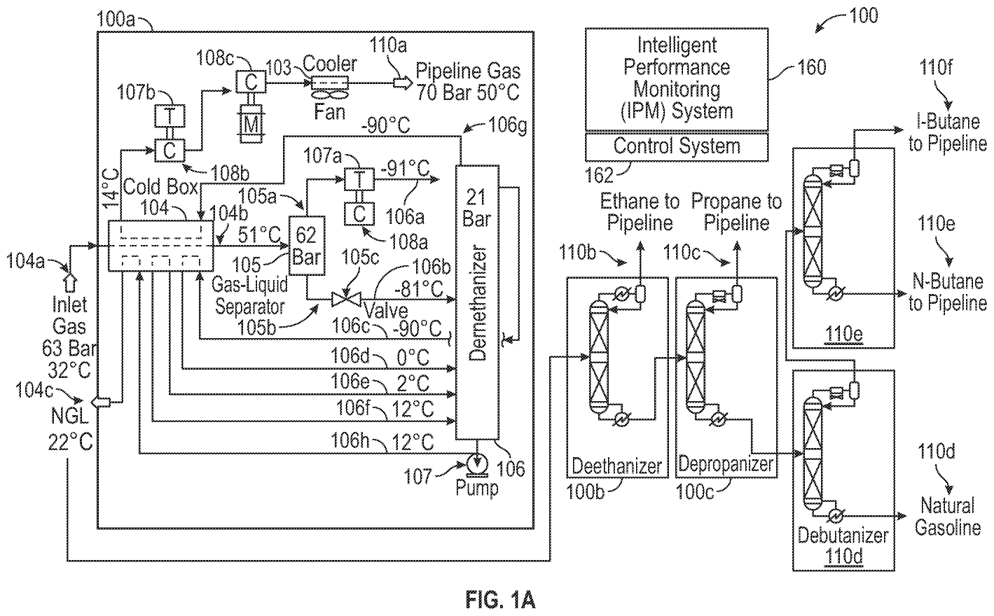

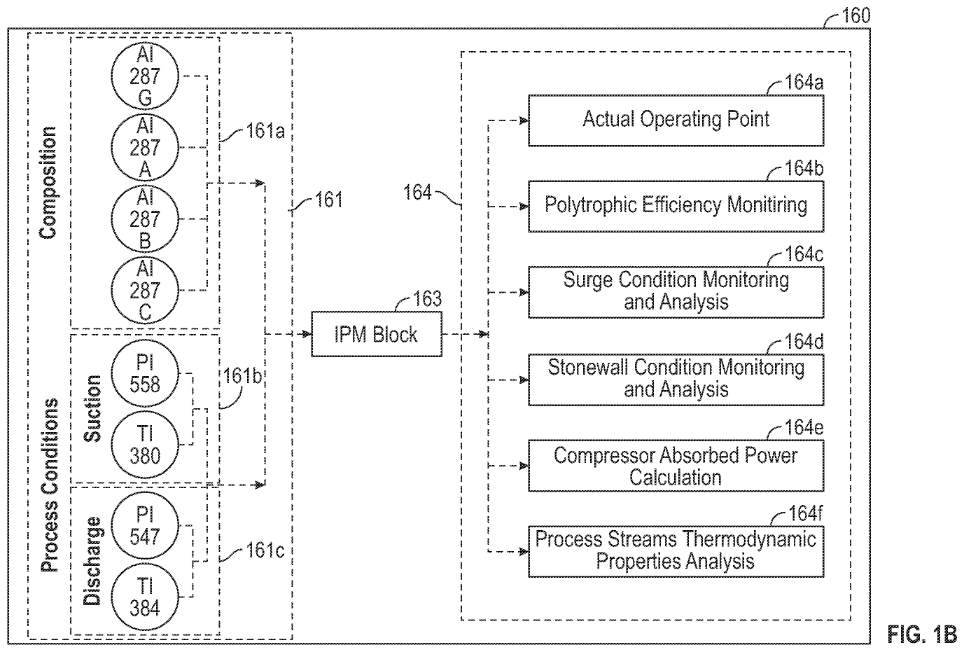

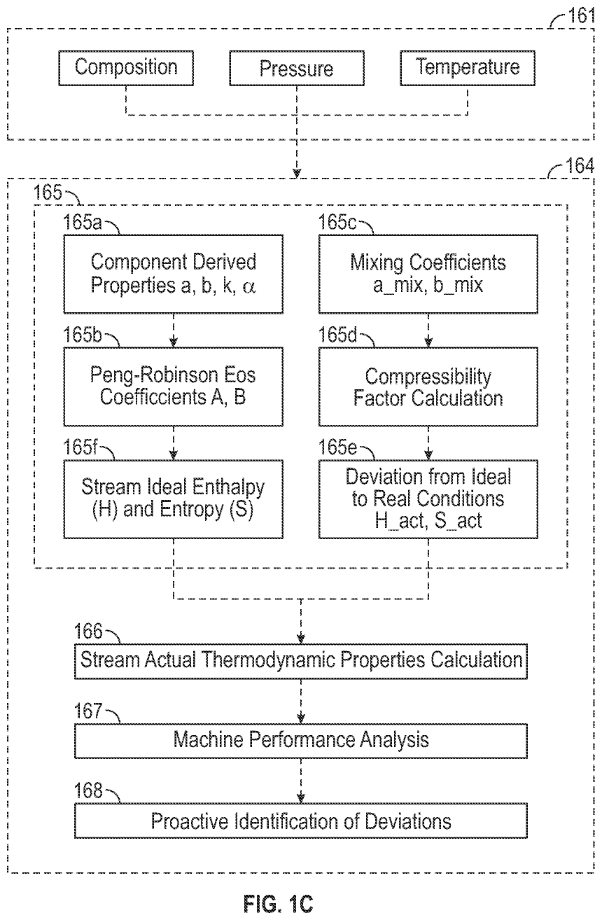

FIG. 1A shows a schematic diagram in accordance with one or more embodiments. More specifically, FIG. 1A illustrates a gas processing plant. In one or more embodiments, the gas processing plant is a NGL plant (100) having a series of fractionators (100a, 100b, 100c, 100d, 100e), hydrocarbon distribution pipelines (110a, 110b, 110c, 110d, 110e, 110f), a control system (162), and an intelligent performance monitoring (IPM) system (160). In one or more embodiments, one or more of the modules and/or elements shown in FIG. 1A may be omitted, repeated, combined and/or substituted. Accordingly, embodiments disclosed herein should not be considered limited to the specific arrangements of modules and/or elements shown in FIG. 1A.

As shown in FIG. 1A, the inlet gas (104a) is raw natural gas that consists primarily of methane along with various amounts of heavier hydrocarbon gases such as ethane, propane, normal butane (n-butane), isobutane (i-butane), etc. When processed into finished by-products, these heavier hydrocarbons are collectively referred to as natural-gas liquids (NGL) (104c). The extraction of the NGL (104c) involves a turboexpander (107a), a compressor (108a), and a distillation column referred to as a demethanizer (106). The inlet gas (104a) is first cooled to about −51° C. in a heat exchanger referred to as a cold box (104), which partially condenses the inlet gas (104a). The resultant gas-liquid mixture (104b) is then separated through the gas-liquid separator (105) into a gas stream (105a) and a liquid stream (105b).

The liquid stream (105b) from the gas-liquid separator (105) flows through a valve (105c) and undergoes a throttling expansion from an absolute pressure of 62 bar to 21 bar (6.2 to 2.1 MPa), which is an isenthalpic process (i.e., a constant-enthalpy process) that results in lowering the temperature of the liquid stream from about −51° C. to about −81° C. as the liquid stream (106b) enters the demethanizer (106).

The gas stream (105a) from the gas-liquid separator (105) enters the turboexpander (107a), where it undergoes an isentropic expansion from an absolute pressure of 62 bar to 21 bar (6.2 to 2.1 MPa) that lowers the gas stream temperature from about −51° C. to about −91° C. as the gas stream (106a) enters the demethanizer (106) to serve as distillation reflux.

Liquid stream (106c) from the top tray of the demethanizer (106) (at about −90° C.) is routed through the cold box (104), where it is warmed to about 0° C. as it cools the inlet gas (104a), and then returns as liquid stream (106d) to the lower section of the demethanizer (106). Another liquid stream (106e) from the lower section of the demethanizer (106) (at about 2° C.) is routed through the cold box (104) and returns as liquid stream (106f) to the demethanizer (106) at about 12° C. In effect, the inlet gas (104a) provides the heat required to “reboil” the bottom of the demethanizer (106), and the turboexpander (107a) removes the heat required to provide reflux in the top of the demethanizer (106).

The overhead gas product (106g) from the demethanizer (106) at about −90° C. is processed natural gas that is of suitable quality for distribution to end-use consumers by pipeline. It is routed through the cold box (104), where it is warmed as it cools the inlet gas (104a). It is then compressed in the gas compressor (108b) driven by the turboexpander (107b) and further compressed in a second-stage gas compressor (108c) driven by an electric motor before entering a cooler (103) and the methane pipeline (110a).

The bottom product (106h) from the demethanizer (106) is pumped out using a pump (107) and also warmed in the cold box (104), as it cools the inlet gas (104a) before leaving the fractionator (100a) as NGL (104c). The NGL (104c) is inputted into the series of fractionators (110b, 10c, 110d, 110e) and separated into ethane, propane, and butanes. Each of the fractionators (110b, 10c, 110d, 110e) includes similar equipment as the fractionator (110a), namely, the turboexpander, compressor, distillation column, and other associated equipment.

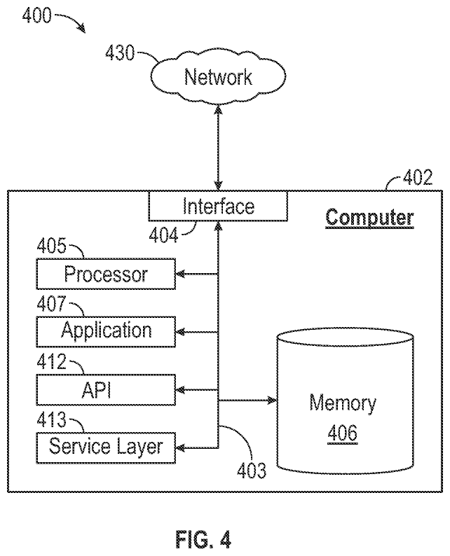

In one or more embodiments, the control system (162) may control various operation parameters of the NGL plant (100), such pressure, temperature, electrical power, etc. In some embodiments, the control system (162) is a part of a distributed control system (DCS) of the NGL plant (100). In some embodiments, the control system (162) includes a computer system that is similar to the computing system (400) described below with regard to FIG. 4 and the accompanying description.

The IPM system (160) is a monitoring and advisory system that includes hardware and/or software with functionality for facilitating operations of the NGL plant (100), such as production operations, maintenance operations, and assessment and development operations. In some embodiments, the IPM system (160) is integrated with the DCS of the NGL plant (100). The IPM system (160) is described in further details in reference to FIGS. 1B-1C below.

While the IPM system (160) is shown at the NGL plant (100), embodiments are contemplated where at least a portion of the IPM system (160) is located away from NGL plants. In some embodiments, the IPM system (160) may include a computer system that is similar to the computing system (400) described below with regard to FIG. 4 and the accompanying description.

FIG. 1B illustrates a process block diagram of the IPM system (160) depicted in FIG. 1A above. In one or more embodiments, one or more of the modules and/or elements shown in FIG. 1B may be omitted, repeated, combined and/or substituted. Accordingly, embodiments disclosed herein should not be considered limited to the specific arrangements of modules and/or elements shown in FIG. 1B.

As noted above, the IPM system (160) is a monitoring and advisory system for the NGL plant (100) that, based on online process conditions, calculates machine performance and analyzes deviations from design specifications. Dynamic analysis results of the IPM system (160) may be displayed in a DCS screen. During unsafe conditions, warning alarm and guide message generated by the IPM system (160) are displayed in the DCS screen to alert the plant operator regarding required actions to return equipment of the NGL plant (100) back to a normal operating parameter window. For example, the plant operator may use the control system (162) to adjust the operating parameters of the NGL plant equipment to restore the normal operations of the NGL plant (100). Throughout this disclosure, the terms “equipment” and “machine” are used interchangeably.

As shown in FIG. 1B, the IPM system (160) is based on a calculation block (i.e., IPM block (163)) using functional modules (164) to perform various online calculations on input to provide actual thermodynamic properties of inlet and outlet streams of the compressor, such as the compressor (108b) depicted in FIG. 1A above. In one or more embodiments, the input to the calculation block includes online process condition parameters (161). The actual thermodynamic properties are used to calculate and analyses performance indicators and assess operation of the machines in the NGL plant (100). The IPM block (163) uses online process conditions used as the input (161) that includes stream composition (161a) and pressure and temperature conditions, i.e., suction parameters (161b) of the inlet stream and discharge parameters (161b) of the outlet stream.

Specifically, the functional modules (164) include functional module (164a) through functional module (164f). The functional module (164a) performs online calculation of compressor operating point on a performance curve. The functional module (164b) performs online calculation of actual polytrophic efficiency of the compressor. The functional modules (164c, 164d) perform online calculation of actual surge and stone wall limits and deviation from them. According to the calculated deviation, warning alarms may be generated to alert plant operator that the compressor is approaching an unsafe operating condition, such as the surge or stonewall zone. The functional module (164e) performs online calculation of actual absorbed power of the compressor. The functional modules (164f) performs online calculation of process stream parameters, e.g., actual volumetric flow, density, etc.

The online calculations use the functional modules (164) to reflect all changes in stream composition, pressure and temperature and by means of applying gas components mixing rules, Peng-Robinson Equation of State and correlations to compute machine performance parameters. FIG. 1C illustrates an overview of the calculations performed by the functional modules (164). As shown in FIG. 1C, online process condition parameters (161) is inputted into the functional modules (164) to perform initial calculations (165). In the initial calculation (165), gas components mixing rules and Peng-Robinson Equation of State are applied with various coefficients (165a, 165b, 165c) to generate various calculation results (165d, 165e, 165f). In addition, the functional modules (164) performs additional calculations (166, 167, 168). Details of the initial calculation (165) and additional calculations (166, 167, 168) are described in detail below.

These calculation results are summarized in DCS dashboard that displays actual operating point on performance curve and machine key performance indicators. In particular, online calculation of stonewall and surge limits allows plant operator to understand operating safety margin, i.e., how far the current operating conditions are from unsafe operating zone. Proactive deviation alarms and guide messages help plant operators to control machine from entering the unsafe operating zone. Actual polytrophic efficiency, adsorbed power calculations provide machine condition status and allow plant operators to identify long-term performance deterioration trends.

The following provides details of calculations (165, 166, 167, 168) incorporated into the functional modules (164) of the calculation block as shown in FIGS. 1B-1C. The input data of online process condition parameters (161) include the following data in LIST 1. Note that Nitrogen, methane, ethane, propane, and butane are denoted as N2, C1, C2, and C3, respectively.

### List 1

1) Gas composition (161a) measured at the inlet of the compressor, such as the compressor (108b) depicted in FIG. 1A above:
N2 4XAI287G.PV, MOL %. N2_MOL=MOL %/100
C1 4XAI287A.PV, MOL %. C1_MOL=MOL %/100
C2 4XAI287B.PV, MOL %. C2_MOL=MOL %/100
C3 4XAI287C.PV, MOL %. C3_MOL=MOL %/100,
where 4XAI287G.PV is the DCS tag for the gas chromatography analyzer that measure the composition of the gas. The value=MOL %/100 is a generalization for the reading in mole percent in the DCS. For example, the composition for the N2 is equal to 7/100 which equals to 0.07.
2) Suction parameters (161b) measured at the inlet of the compressor, such as the compressor (108b) depicted in FIG. 1A above:
Suction pressure P1 (psi) 4XPI558.PV. P1_ABSPA=(P+14.7)*6894.75 Pa (a)
Suction temperature T1 (F) 4XTI380.PV. T1_KELVIN=(T−32)*5/9+273.15 K
Flow F (MMSCFD) F 4XFI265.PV
Speed S (RPM) 4XSIC311.PV,
where 4XPI558.PV is the tag in the DCS for the suction pressure were 4X is an abbreviation for multiple trains (e.g., 41, 42 & 43). ABSPA is a unit for pressure which stands for absolute pascal.
3) Discharge parameters (161c) measured at the outlet of the compressor, such as the compressor (108b) depicted in FIG. 1A above:
Discharge pressure P2 (psi) 4XPI547.PV. P1_ABSPA=(P+14.7)*6894.75 Pa (a)
Discharge temperature T2 (F) 4XTI384.PV. T1_KELVIN=(T−32)*5/9+273.15 K
4) Constants
Standard conditions:
Standard Pstd ABSPA=101325
Standard Tstd K=288.15
Reference conditions:
Reference Pref ABSPA=101325
Standard Tstd K=298.15
Gas constant R=8.31451

The calculation formulae and coefficients used in the functional modules (164a, 164b, 164c, 164d, 164e, 164f) for calculations (165, 166, 167, 168) are described below. In Block 165a, Component derived properties a, b, α, K are listed below:

| Component | a | b | K | AA |
|---|---|---|---|---|
| N2 | 0.148 | 2.41*10\hat{ }−5 | 0.436 | 0.148* α_{N2} |
| C1 | 0.248 | 2.66*10\hat{ }−5 | 0.392 | 0.248* α_{C1} |
| C2 | 0.604 | 4.05*10\hat{ }−5 | 0.524 | 0.604* α_{C2} |
| C3 | 1.016 | 5.62*10\hat{ }−5 | 0.603 | 1.016* α_{C3} |

$$\begin{matrix}a = 0.45724 \cdot \frac{{R}^{2} \cdot {T}_{c}^{2}}{{P}_{c}} \\ b = 0.0778 \cdot R \cdot \frac{{T}_{c}}{{P}_{c}} \\ K = 0.37464 + 1.54226 \cdot ω - 0.26992 \cdot {ω}^{2} \\ α = {( 1 + K \cdot ( 1 - \sqrt{\frac{T}{{T}_{c}}} ) )}^{2}\end{matrix}$$

where
ω is the Pitzer's acentric factor of the given component;
T_{c} is the critical temperature of the given component;
P_{c} is the critical pressure of the given component.

| | Mol Weight | T_{□} | P_{□} | ω |
|---|---|---|---|---|
| Component | kg/kmol | K | kPa | — |
| Nitrogen | 28.013 | 126.194 | 3394.37 | 0.040000 |
| Methane | 16.043 | 190.699 | 4640.68 | 0.011498 |
| Ethane | 30.070 | 305.428 | 4883.85 | 0.098600 |
| Propane | 44.097 | 369.898 | 4256.66 | 0.152400 |

In Block 165b in FIG. 1C, EOS coefficients A, B are used in Compressibility factor (Z) calculation below:

Z is calculated by solving Peng-Robinson EOS for gas mixture. Peng-Robinson EOS is a cubic equation:

$${Z}^{3} - ( 1 - B ) \cdot {Z}^{2} + ( A - 2 B - 3 {B}^{2} ) \cdot Z - ( AB - {B}^{2} - {B}^{3} ) = 0$$

Coefficients A and B are defined as:

$$\begin{matrix}A = \frac{{( a \cdot α )}^{mix} \cdot P}{{R}^{2} \cdot {T}^{2}} \\ B = \frac{{b}^{mix} \cdot P}{R \cdot T}\end{matrix}$$

For gas mixtures, mixing rules have to be applied to obtain (α·α)^{mix} and b^{mix} above that are referred to in Block 165c of FIG. 1B. In the mixing rules, kᵢⱼ are binary interaction parameters for the pairs of components.

| | Binary interaction parameters | | | |
|---|---|---|---|---|
| | Nitrogen | Methane | Ethane | Propane |
| Nitrogen | 0 | 0.035999 | 0.050000 | 0.079998 |
| Methane | 0.035999 | 0 | 0.002241 | 0.006829 |
| Ethane | 0.050000 | 0.002241 | 0 | 0.001258 |
| Propane | 0.079998 | 0.006829 | 0.001258 | 0 |

| Mixture | kᵢⱼ | l − kᵢⱼ |
|---|---|---|
| N2C1 | 0.036 | 0.964 |
| N2C2 | 0.05 | 0.95 |
| N2C3 | 0.08 | 0.92 |
| C1C2 | 0.002 | 0.998 |
| C1C3 | 0.007 | 0.993 |
| C2C3 | 0.0013 | 0.9987 |

kᵢⱼ are binary interaction parameters for the pairs of components. The binary interaction parameters are constants to account for the interactions between the molecules in a gaseous mixture in Peng-Robinson cubic equation of state. y_{N2} is the mole fraction calculated above as per the figure below

$$( {y}_{N 2} = \frac{N {2}_{MOL}}{N {2}_{MOL} + C {1}_{MOL} + C {2}_{MOL} + C {3}_{MOL}} .$$

1−kᵢⱼ and yᵢ is used in the calculation of Mᵢⱼ as per the equations below.

$$\begin{matrix}{M}_{N 2 N 2} = {y}_{N 2} * {y}_{N 2} * {AA}_{N 2} \\ {M}_{C 1 C 1} = {y}_{C 1} * {y}_{C 1} * {AA}_{C 1} \\ {M}_{C 2 C 2} = {y}_{C 2} * {y}_{C 2} * {AA}_{C 2} \\ {M}_{C 3 C 3} = {y}_{C 3} * {y}_{C 3} * {AA}_{C 3} \\ {M}_{N 2 C 1} = 0.964 * {y}_{N 2} * {y}_{C 1} * {( {AA}_{N 2} * {AA}_{C 1} )}^{0.5} \\ {M}_{N 2 C 2} = 0.95 * {y}_{N 2} * {y}_{C 2} * {( {AA}_{N 2} * {AA}_{C 2} )}^{0.5} \\ {M}_{N 2 C 3} = 0.92 * {y}_{N 2} * {y}_{C 3} * {( {AA}_{N 2} * {AA}_{C 3} )}^{0.5} \\ {M}_{C 1 C 2} = 0.998 * {y}_{C 1} * {y}_{C 2} * {( {AA}_{C 1} * {AA}_{C 2} )}^{0.5} \\ {M}_{C 1 C 3} = 0.993 * {y}_{C 1} * {y}_{C3} * {( {AA}_{C 1} * {AA}_{C 3} )}^{0.5} \\ {M}_{C2C 3} = 0.9987 * {y}_{C 2} * {y}_{C 3} * {( {AA}_{C 2} * {AA}_{C 3} )}^{0.5} \\ {MIX}_{N 2} = {M}_{N 2 N 2} + {M}_{N 2 C 1} + {M}_{N 2 C 2} + {M}_{N 2 C 3} \\ {MIX}_{C 1} = {M}_{C 1 C 1} + {M}_{N 2 C 1} + {M}_{C 1 C 2} + {M}_{C 1 C 3} \\ {MIX}_{C 2} = {M}_{C 2 C 2} + {M}_{N 2 C 2} + {M}_{C 1 C 2} + {M}_{C 2 C 3} \\ {MIX}_{C 3} = {M}_{C 3 C 3} + {M}_{N 2 C 3} + {M}_{C 1 C 3} + {M}_{C 2 C 3} \\ {( a \cdot α )}^{mix} = {MIX}_{N 2} + {MIX}_{C 1} + {MIX}_{C 2} + {MIX}_{C 3}\end{matrix}$$

b^{mix}=Σyᵢ·bᵢ, where bᵢ is the parameter “b” in the TABLE above that is calculated for each component in the gas (e.g., b_{N2})

Solution of cubic EOS includes the following steps. Given the cubic equation with real coefficients

$${Z}^{3} + x \cdot {Z}^{2} + y \cdot Z + d = 0$$

The first step is to calculate the parameters:

$$p = y - \frac{{x}^{2}}{3}$$

$$q = 2 \cdot \frac{{x}^{3}}{27} - x \cdot \frac{y}{3} + d ,$$

where x, y, and d are auxiliary coefficients used to solve the cubic equation.

For Peng-Robinson equation these coefficients will be:

$$\begin{matrix}x = B - 1 \\ y = A - 2 B - 3 \cdot {B}^{2} \\ d = {B}^{3} + {B}^{2} - A \cdot B\end{matrix}$$

The second step is to define discriminant:

$$r = {( \frac{p}{3} )}^{3} + {( \frac{q}{2} )}^{2}$$

Third step is to calculate compressibility factor Z:

If r>0, then

$$Z 1 = {( - \frac{q}{2} + \sqrt{r} )}^{1 / 3} + {( - \frac{q}{2} - \sqrt{r} )}^{1 / 3} - \frac{a}{3}$$

If r=0, then two roots available and highest value selected:

$$\begin{matrix}Z 1 = - 2 \cdot {( \frac{q}{2} )}^{1 / 3} - \frac{a}{3} \\ Z 2 = - {( \frac{q}{2} )}^{1 / 3} - \frac{a}{3}\end{matrix}$$

If r<0, then three roots available and highest selected:

$$Z 1 = 2 \cdot ( \sqrt{( - \frac{p}{3} )} \cdot cos ( \frac{acos ( \sqrt{\frac{\frac{{q}^{2}}{4}}{- \frac{{p}^{3}}{27}}} )}{3} ) - \frac{a}{3}$$

$$Z 2 = 2 \cdot ( \sqrt{( - \frac{p}{3} )} \cdot cos ( \frac{acos ( \sqrt{\frac{\frac{{q}^{2}}{4}}{- \frac{{p}^{3}}{27}}} )}{3} ) + 2.09 ) - \frac{a}{3}$$

$$Z 3 = 2 \cdot ( \sqrt{( - \frac{p}{3} )} \cdot cos ( ( \frac{acos ( \sqrt{\frac{\frac{{q}^{2}}{4}}{- \frac{{p}^{3}}{27}}} )}{3} ) + 1.05 ) ) - \frac{a}{3}$$

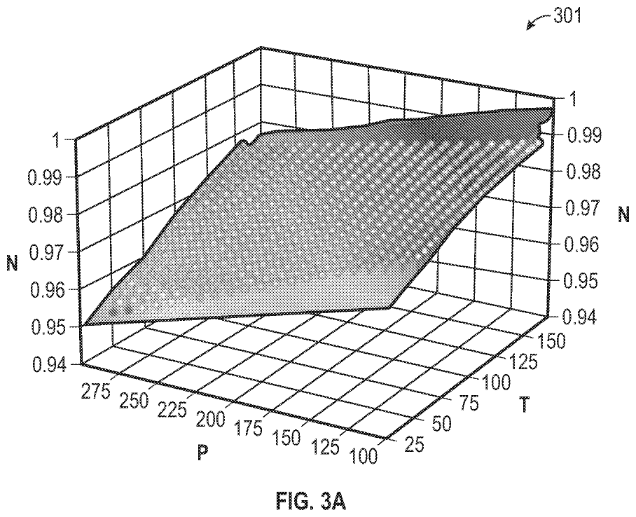

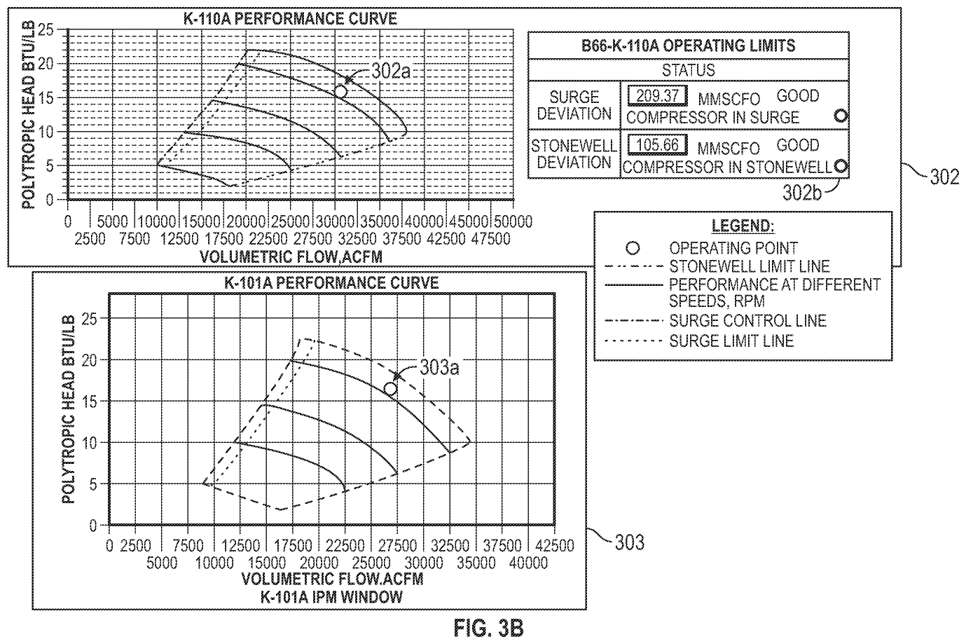

Alternatively, gas compressibility (Z) can be obtained by building correlations. Correlations allows calculating gas mixture compressibility factor by utilizing only one formula obtained from correlations. For instance, based on the correlation graph shown in FIG. 3A, the compressibility equation will be:

$$Z = \frac{( a + b * T + c * {T}^{2} + d * P )}{( 1 + e * T + f * {T}^{2} + g * P )}$$

where:
T denotes stream temperature in F
P denotes stream pressure in psi
a, b, c, d, e, f, g denote equation coefficients
a=0.99996428
b=0.0062149212
c=4.1551099*10\hat{ }−5
d=7.7558113*10\hat{ }−5
e=0.0062677135
f=4.1390104*10\hat{ }−5
g=0.00032572002

Compressibility factor (Z) is calculated for inlet and outlet conditions Z1 and Z2 of the compressor, such as the compressor (108b) depicted in FIG. 1A above. In Block 165f of FIG. 1B, Enthalpy is calculated as below:

To calculate enthalpy, a reference enthalpy is defined at a given temperature and pressure then calculate the change in enthalpy to the actual pressure and temperature in two steps-first an ideal step (no change in pressure), then a departure function to account for non-ideality at high pressure:

$$H = {H}_{ref} + {dH}^{ideal} + {H}^{departure}$$

Reference enthalpy is sum of components mole fractions multiplied by enthalpy of formation at reference conditions:

$${H}_{ref} = \sum {y}_{i} \cdot {dH}_{i}^{0}$$

where yᵢ is the mole fraction of component i and dHᵢ⁰ is the enthalpy of formation of component i at reference conditions, kJ/kmol.

| Component | dHᵢ⁰, kJ/kmol | dSᵢ⁰, kJ/(kmol · K) |
|---|---|---|
| Nitrogen | 0 | 148.063 |
| Methane | −74900 | 183.476 |
| Ethane | −84738 | 195.219 |
| Propane | −103890 | 161.655 |

### a) Calculate Ideal Enthalpy for Each Component:

$${dH}_{i}^{ideal} = A \cdot ( T - {T}_{ref} ) + \frac{B}{2} \cdot ( {T}^{2} - {T}_{ref}^{2} ) + \frac{C}{3} \cdot ( {T}^{3} - {T}_{ref}^{3} ) + \frac{D}{4} \cdot ( {T}^{4} - {T}_{ref}^{4} ) + \frac{E}{5} \cdot ( {T}^{5} - {T}_{ref}^{5} )$$

where T_{ref} is a reference temperature (298.15 K);
T is an actual temperature, K;
A, B, C, D, E are coefficients:

| Component | A | B | C | D | E |
|---|---|---|---|---|---|
| Nitrogen | 2.753E+01 | 5.443E−03 | −3.494E−08 | −4.096E−10 | 5.673E−14 |
| Methane | 3.793E+01 | −6.842E−02 | 2.725E−04 | −2.390E−07 | 6.906E−11 |
| Ethane | 3.437E+01 | −1.946E−02 | 3.828E−04 | −4.081E−07 | 1.326E−10 |
| Propane | 1.742E+01 | 1.865E−01 | 5.245E−05 | −1.177E−07 | 3.703E−11 |

### Calculate Ideal Enthalpy for Mixture:

$${dH}_{ideal} = \sum {y}_{i} \cdot {dH}_{i}^{ideal}$$

### Calculate Departure Enthalpy:

$${H}^{departure} = ( 1 - Z - ln \frac{Z + ( 1 + \sqrt{2} ) \cdot B}{Z + ( 1 - \sqrt{2} ) \cdot B} \cdot \frac{A}{B \cdot \sqrt{8}} \cdot ( 1 + {K}^{mix} \cdot \frac{\sqrt{\frac{T}{{T}_{c}^{mix}}}}{\sqrt{{α}^{mix}}} ) ) \cdot R \cdot T$$

where Z is a compressibility of the gas;
T_{c}^{mix} is critical temperature of the gas mixture, K;
A, B are coefficients from Peng-Robinson EOS;
α^{mix}, K^{mix} are component-derived properties for gas mixture.
R is the gas constant, 8.3144 J/(mol·K).

### Critical Temperature for the Gas Mixture is Calculated as:

$${T}_{c}^{mix} = \sum {T}_{i}^{c} \cdot {y}_{i}$$

where Tᵢ^{c} is a critical temperature of the component i.

| | Mol Weight | T_{c} | P_{c} |
|---|---|---|---|
| Component | kg/kmol | K | kPa |
| Nitrogen | 28.013 | 126.194 | 3394.37 |
| Methane | 16.043 | 190.699 | 4640.68 |
| Ethane | 30.070 | 305.428 | 4883.85 |
| Propane | 44.097 | 369.898 | 4256.66 |

Similar to critical temperature parameters K and a for the gas mixture are calculated as:

$$\begin{matrix}{K}^{mix} = \sum {K}_{i} \cdot {y}_{i} \\ {α}^{mix} = \sum {α}_{i} \cdot {y}_{i}\end{matrix}$$

### Calculate Stream Enthalpy:

$$H = {H}_{ref} + {dH}^{ideal} + {H}^{departure}$$

Calculated enthalpy will be in kJ/kmol units. To convert it to BTU/lb:

### Calculate Molecular Weight of Gas Mixture:

$$MW = N {2}_{MOL} * 28 + C {1}_{MOL} * 16 + C {2}_{MOL} * 30 + C {3}_{MOL} * 44$$

Convert Enthalpy from kJ/Kmol to BTU/Lb

$${H}_{BTU} = \frac{{H}_{kJ}}{MW} * 0.429923$$

In addition, in Block 165c of FIG. 1C, entropy is calculated. Entropy is calculated similar to enthalpy-initially reference entropy at a given temperature and pressure is calculated then change in entropy to the actual pressure and temperature in two steps-first an ideal step (no change in pressure), then a departure function to account for non-ideality at high pressure. Additionally, entropy of mixing is calculated.

$$S = {S}_{ref} + {dS}^{ideal} + {S}^{departure} + {dS}^{mixing} - R \cdot ln \frac{P}{{P}_{ref}}$$

Calculate reference entropy. Reference entropy is sum of components mole fractions multiplied by entropy of formation at reference conditions

$${S}_{ref} = \sum {y}_{i} \cdot {dS}_{i}^{0}$$

where dSᵢ⁰ is the enthalpy of formation of component i at reference conditions, kJ/(kmol·K).

### Calculate Ideal Entropy for Each Component:

$${dS}_{i}^{ideal} = A \cdot ln \frac{T}{{T}_{ref}} + B \cdot ( T - {T}_{ref} ) + \frac{C}{2} \cdot ( {T}^{2} - {T}_{ref}^{2} ) + \frac{D}{3} \cdot ( {T}^{3} - {T}_{ref}^{3} ) + \frac{E}{4} \cdot ( {T}^{4} - {T}_{ref}^{4} )$$

### Calculate Ideal Entropy for Mixture:

$${dS}_{ideal} = \sum {y}_{i} \cdot {dS}_{i}^{ideal}$$

### Calculate Departure Entropy:

$${S}^{departure} = R \cdot ln ( Z - B ) - ln \frac{Z + ( 1 + \sqrt{2} ) \cdot B}{Z + ( 1 - \sqrt{2} ) \cdot B} \cdot \frac{A \cdot R}{B \cdot \sqrt{8}} \cdot {K}^{mix} \cdot \frac{\sqrt{\frac{T}{{T}_{c}^{mix}}}}{\sqrt{{α}^{mix}}}$$

### Calculate Mixing Entropy for Key Components:

$${dS}^{mixing} = - R \cdot ( {N}_{{2}_{MOL}} \cdot ln ( {N}_{{2}_{MOL}} ) + {C}_{{1}_{MOL}} \cdot ln ( {C}_{{1}_{MOL}} ) )$$

### Calculate Stream Entropy:

$$S = {S}_{ref} + {dS}^{ideal} + {S}^{departure} + {dS}^{mixing} - R \cdot ln \frac{P}{{P}_{ref}}$$

In Blocks 166, 167, 168, Compressor IPM parameters are calculated as below:

### Calculate Polytrophic Head:

$${H}_{P} = ( {H}_{2} - {H}_{1} ) - \frac{( {S}_{2} - {S}_{1} ) \cdot ( {T}_{2} - {T}_{1} )}{ln \frac{{T}_{2}}{{T}_{1}}}$$

### Calculate Polytrophic Efficiency:

$$η = \frac{{H}_{P}}{{H}_{2} - {H}_{1}}$$

### Calculate Compressor Actual Suction Flow:

$${F}_{act} , ACFM = {F}_{std} , MMSCFD * ( \frac{{P}_{std}}{{P}_{act}} ) * ( \frac{{T}_{act}}{{T}_{std}} ) * ( \frac{z}{1} ) * {10}^{6} * ( \frac{1}{24} ) * ( \frac{1}{60} )$$

### Calculate Compressor Stonewall Limit:

$${F}_{stonewall} , ACFM = Speed , rpm * 3.2 \\ {F}_{stonewall} , MMSCFD = {F}_{stonewall} , \\ ACFM * ( \frac{{P}_{act}}{{P}_{std}} ) * ( \frac{{T}_{std}}{{T}_{act}} ) * ( \frac{1}{z} ) * ( \frac{1}{{10}^{6}} ) * 24 * 60$$

In Block 165e, calculate deviation from stonewall limit:

Dev_{stonewall}=F_{stonewall},MMSCFD−F_{std},MMSCFD

If deviations reach critical set point of +10 MMSCFD dashboard status will change from GOOD to DANGER and operator will receive following guide message to reduce flow through the machine

### Calculate Compressor Surge Limit:

$${F}_{surge} , ACFM = Speed , rpm * 1.8 \\ {F}_{surge} , MMSCFD = {F}_{surge} , ACFM * ( \frac{{P}_{act}}{{P}_{std}} ) * ( \frac{{T}_{std}}{{T}_{act}} ) * ( \frac{1}{z} ) * ( \frac{1}{{10}^{6}} ) * 24 * 60$$

Calculate Deviation from Stonewall Limit:

$${Dev}_{stonewall} = {F}_{std} , MMSCFD - {F}_{surge} , MMSCFD$$

If deviations reach critical set point of +10 MMSCFD dashboard status will change from GOOD to DANGER and operator will receive following guide message to check functionality of anti-surge system

### Calculate Inlet/Outlet Stream Densities:

$${Density}_{IN} , \frac{lb}{{ft}^{3}} = \frac{{P}_{in} * MW}{{Z}_{in} * R * {T}_{in}} * 0.0624 \\ {Density}_{OUT} , \frac{lb}{{ft}^{3}} = \frac{{P}_{out} * MW}{{Z}_{out} * R * {T}_{out}} * 0.0624$$

### Calculate Compressor Mass Flow:

$${F}_{mass} , \frac{lb}{h} = {F}_{act} , ACFM * {Density}_{IN} , \frac{lb}{{ft}^{3}} * 60$$

### Calculate Compressor Power:

$$POWER , HP = ( {H}_{p} , \frac{BTU}{lb} * {F}_{mass} , \frac{lb}{h} ) / 41.83$$

Furthermore, an artificially intelligent powered multivariable controller may be trained utilizing the actual efficiency point to develop an AI powered controller to account for the different operation modes such as startup mode, shutdown mode, trip mode where the equipment is above or below trained capacity.

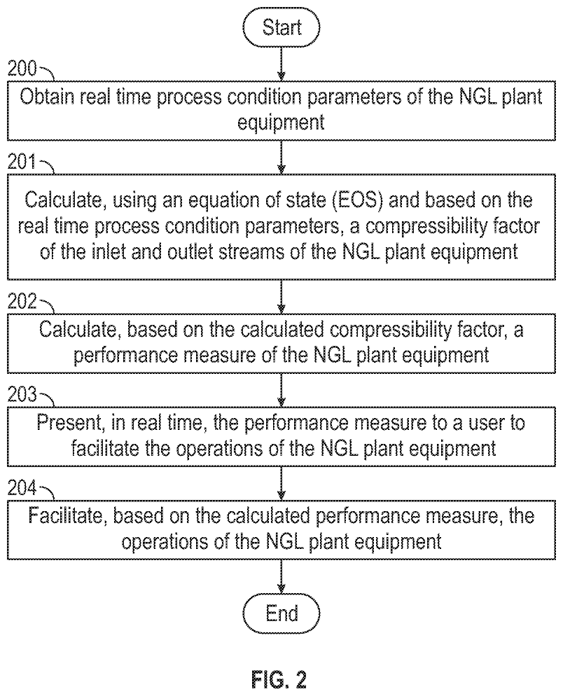

FIG. 2 shows a flowchart in accordance with one or more embodiments disclosed herein. One or more of the steps in FIG. 2 may be performed by the IPM system (160), discussed above in reference to FIGS. 1A-1C. In one or more embodiments, one or more of the steps shown in FIG. 2 may be omitted, repeated, and/or performed in a different order than the order shown in FIG. 2. Accordingly, the scope of the disclosure should not be considered limited to the specific arrangement of steps shown in FIG. 2.

Initially in Step 200, real time process condition parameters of the NGL plant equipment are obtained. Sensors are installed at the inlet and outlet of the NGL equipment to measure the process condition parameters during operation of the NGL equipment. In other words, the process condition parameters are measured in real time while the NGL equipment is online. In one or more embodiments, the process condition parameters include pressure, temperature, flow rate, etc. that are measured using pressure sensor, temperature sensor, flow rate sensor, etc.

In Step 201, a compressibility factor of the inlet and outlet streams of the NGL plant equipment is calculated based on the real time process condition parameters. In one or more embodiments, the compressibility factor is calculated using an equation of state (EOS). In one or more embodiments, the Peng-Robinson EOS is used to calculate the compressibility factor. For example, the compressibility factor may be calculated as described in reference to FIGS. 1B-1C above.

In Step 202, a performance measure of the NGL plant equipment is calculated based on calculated compressibility factor. In one or more embodiments, the performance measure includes one or more of the enthalpy, polytropic efficiency, and absorbed power entropy of the NGL plant equipment. For example, these performance measures may be calculated as described in reference to FIGS. 1B-1C above.

In Step 203, the performance measure is presented in real time to a user to facilitate the operations of the NGL plant equipment. In other words, the calculated performance measure is updated in response to any changes in the process condition parameters and presented to the user immediately. For example, the user may be an operator or a supervisor of the NGL plant. In one or more embodiments, the calculated performance measure is displayed in real time on a distributed control system (DCS) screen. For example, the calculated performance measure may be displayed as an operating point on a performance curve of the NGL plant equipment on the DCS screen.

In Step 204, the operations of the NGL plant equipment are facilitated based on the calculated performance measure. In one or more embodiments, a deviation from a target operating condition is determined based on the calculated performance measure and detected as exceeding a pre-determined threshold. An alert message is generated in response to detecting the deviation exceeding the pre-determined threshold. Accordingly, the alert message is presented to the user, e.g., on the DCS screen. In response to the displayed alert message, the user may initiate a corrective action to return the NGL plant equipment to the target operating condition.

FIGS. 3A-3B show an implementation example in accordance with one or more embodiments. As noted above, FIG. 3A shows a correlation graph (301) where the grey scale indicates how close the correlation is to the actual data collected from the field.

FIG. 3B shows two example displays of the DCS screen. In particular, the display (302) and display (303) each shows an operating point (302a, 303a) on a performance curve of polytropic head versus volumetric flow. The polytropic head is a term used for dynamic compressors to denote the foot-pounds of work required per pound of gas. In addition, the display (302) includes an operating status window (302b) where the plant operator may view the surge deviation and stonewall deviation information.

In contrast to conventional practices that use simplified formulae and assumed compressibility factor (Z) to calculate compressor performance parameters, the IPM system described above calculates compressor performance parameters where compressibility is calculated by solving Peng-Robinson Equation of State, enthalpies and entropies are estimated by calculating deviation from ideal conditions, and polytropic head, efficiency and absorbed power of the compressor are calculated from the EOS calculated compressibility factor (Z) and the polytropic head, efficiency and absorbed power of the compressor.

Embodiments provide the following advantages: (i) real time calculation of actual compressibility, enthalpies and entropies allow improved results of machine performance calculation and (ii) integrated IPM calculation functionality incorporated into DCS allowing DCS to perform all calculations independently on real time basis with no human intervention.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (Saas), mobile “backend” as a service (MBaaS), serverless computing, artificial intelligence (AI) as a service (AlaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method to perform operations of a natural gas liquid (NGL) plant equipment, comprising:
obtaining real time process condition parameters of the NGL plant equipment;
calculating, using an equation of state (EOS) and based on the real time process condition parameters, a compressibility factor of inlet and outlet streams of the NGL plant equipment;
calculating, based on the calculated compressibility factor, a performance measure of the NGL plant equipment; and
facilitating, based on the calculated performance measure, the operations of the NGL plant equipment.

2. The method of claim 1, further comprising:
presenting, in real time, the performance measure to a user to facilitate the operations of the NGL plant equipment.

3. The method of claim 2, wherein facilitating the operations of the NGL plant equipment comprises:
detecting, based on the performance measure, a deviation from a target operating condition exceeding a pre-determined threshold;
generating, in response to said detecting, an alert message; and
presenting the alert message to the user.

4. The method of claim 3,
wherein the user initiate a corrective action to return the NGL plant equipment to the target operating condition.

5. The method of claim 1, wherein calculating the performance measure comprises:
calculating, based on calculated compressibility factor, enthalpy and entropy of the NGL plant equipment.

6. The method of claim 1, wherein calculating the performance measure comprises:
calculating, based on calculated compressibility factor, a polytropic efficiency and absorbed power of the NGL plant equipment.

7. The method of claim 2, wherein presenting the performance measure comprises:
presenting, to the user in real time and on a distributed control system (DCS) screen, an operating point on a performance curve of the NGL plant equipment.

8. An intelligent performance monitoring (IPM) system to perform operations of a natural gas liquid (NGL) plant equipment, comprising:
a computer processor; and
memory storing instructions, when executed by the computer processor comprising functionality for:
obtaining real time process condition parameters of the NGL plant equipment;
calculating, using an equation of state (EOS) and based on the real time process condition parameters, a compressibility factor of inlet and outlet streams of the NGL plant equipment;
calculating, based on calculated compressibility factor, a performance measure of the NGL plant equipment; and
facilitating, based on the calculated performance measure, the operations of the NGL plant equipment.

9. The IPM system of claim 8, the instructions, when executed by the computer processor further comprising functionality for:
presenting, in real time, the performance measure to a user to facilitate the operations of the NGL plant equipment.

10. The IPM system of claim 9, wherein facilitating the operations of the NGL plant equipment comprises:
detecting, based on the performance measure, a deviation from a target operating condition exceeding a pre-determined threshold;
generating, in response to said detecting, an alert message; and
presenting the alert message to the user.

11. The IPM system of claim 10,
wherein the user initiate a corrective action to return the NGL plant equipment to the target operating condition.

12. The IPM system of claim 8, wherein calculating the performance measure comprises:
calculating, based on calculated compressibility factor, enthalpy and entropy of the NGL plant equipment.

13. The IPM system of claim 8, wherein calculating the performance measure comprises:
calculating, based on calculated compressibility factor, a polytropic efficiency and absorbed power of the NGL plant equipment.

14. The IPM system of claim 9, wherein presenting the performance measure comprises:
presenting, to the user in real time and on a distributed control system (DCS) screen, an operating point on a performance curve of the NGL plant equipment.

15. A system comprising:
a natural gas liquid (NGL) plant equipment of an NGL plant;
a plurality of sensors disposed at an inlet and an outlet of the NGL plant equipment to measure real time process condition parameters of the NGL plant equipment; and
an intelligent performance monitoring (IPM) system comprising functionality for:
obtaining the real time process condition parameters of the NGL plant equipment;
calculating, using an equation of state (EOS) and based on the real time process condition parameters, a compressibility factor of inlet and outlet streams of the NGL plant equipment;
calculating, based on calculated compressibility factor, a performance measure of the NGL plant equipment; and
facilitating, based on the calculated performance measure, the operations of the NGL plant equipment.

16. The system of claim 15, the IPM system further comprising functionality for:
presenting, in real time and on a distributed control system (DCS) screen, the performance measure to a user to facilitate the operations of the NGL plant equipment,
wherein the performance measure comprises an operating point on a performance curve of the NGL plant equipment.

17. The system of claim 16, wherein facilitating the operations of the NGL plant equipment comprises:
detecting, based on the performance measure, a deviation from a target operating condition exceeding a pre-determined threshold;
generating, in response to said detecting, an alert message; and
presenting the alert message to the user.

18. The system of claim 17,
wherein the user initiate a corrective action to return the NGL plant equipment to the target operating condition.

19. The system of claim 15, wherein calculating the performance measure comprises:
calculating, based on calculated compressibility factor, enthalpy and entropy of the NGL plant equipment.

20. The system of claim 15, wherein calculating the performance measure comprises:
calculating, based on calculated compressibility factor, a polytropic efficiency and absorbed power of the NGL plant equipment.
